(19) United States
(12) Patent Application Publication
(10) Pub. No.: US 2019/0318310 A1
(43) Pub. Date: Oct. 17, 2019

(54) INFORMATION PROCESSING METHOD AND INFORMATION PROCESSING SYSTEM

(71) Applicant: Panasonic Intellectual Property Management Co., Ltd., Osaka (JP)

(72) Inventors: Hirokazu KAWAMOTO, Osaka (JP); Eiichi NAITO, Kyoto (JP)

(21) Appl. No.: 16/381,513

(22) Filed: Apr. 11, 2019

(30) Foreign Application Priority Data
Apr. 17, 2018 (JP) 2018-078783
Oct. 30, 2018 (JP) 2018-203944

(51) Int. Cl. G06Q 10/08; G06Q 50/30; G06Q 50/12

(52) U.S. Cl. CPC G06Q 10/08355; G06Q 50/12; G06Q 50/30; G06Q 10/087

(57) ABSTRACT

An information processing method includes the following processing performed by using a computer. The first order representing an order for a first dish is received from a terminal operated by a first user. A second dish capable of being prepared in parallel with the first dish is determined. Information to encourage ordering the second dish is created. A location associated with the first user is obtained. A second user associated with a location within a predetermined distance from the location associated with the first user is identified. The information is sent to a terminal operated by the second user.

### CROSS REFERENCE TO RELATED APPLICATION

This application claims the benefit of priority of Japanese Patent Application Number 2018-078783 filed on Apr. 17, 2018, and Japanese Patent Application Number 2018-203944 filed on Oct. 30, 2018, the entire content of which is hereby incorporated by reference.

### BACKGROUND

### 1. Technical Field

The present disclosure relates to an information processing method and an information processing system.

### 2. Description of the Related Art

With recent developments in the information processing technology, food delivery services, in which delivery is requested upon ordering a dish online, are becoming increasingly common. This is partly attributed to the availability of online ordering, which was not possible in conventional delivery services provided by restaurants.

Aiming to consolidate deliveries or expand supply during slack periods, delivery service providers provide advertising information to stimulate demand from users for delivery services.

As a technique of providing such advertising information, there is a disclosed method of providing advertising information to encourage users who reside near a user who has already ordered to order if the maximum amount of items that a deliverer can deliver in one trip is not reached (e.g., Japanese

### SUMMARY

However, for a conventional technique as disclosed in Japanese Unexamined Patent Application Publication No. 2015-52943, when a dish is delivered, there is a possibility of a decrease in the quality of the dish. For instance, in the invention disclosed in Japanese Unexamined Patent Application Publication No. 2015-52943, only whether the maximum amount of items that a deliverer can deliver in one trip is reached is determined, and the features of a delivery item are not considered. However, preparation of a dish starts after receiving an order, and after a dish is completed, the quality of the dish decreases as time elapses. Thus, if the conventional technique is directly employed in dish delivery, it may be difficult to maintain the quality of a delivery dish while providing efficient delivery.

The present disclosure has been made to address the above problem, and the objective of the present disclosure is to provide an information processing method and an information processing system that enable both the maintenance of quality of a delivery dish and efficient delivery.

An information processing method according to an aspect of the present disclosure includes the following processing performed by using a computer. The first order representing an order for a first dish is received from a first terminal operated by a first user. A second dish capable of being prepared in parallel with the first dish is determined. Information to encourage ordering the second dish is created. A location associated with the first user is obtained. A second user is identified in accordance with the location associated with the first user. The information is sent to a second terminal operated by the second user.

It should be noted that these comprehensive or specific aspects may be realized by a system, a device, a method, a recording medium, or a computer program or may be realized by a given combination of a system, a device, a method, a recording medium, and a computer program.

An information processing method according to an aspect of the present disclosure enables both the maintenance of quality of a delivery dish and efficient delivery.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 schematically illustrates Application Example 1 of an information processing system in an embodiment;

FIG. 2 schematically illustrates the configuration of the information processing system in the embodiment;

FIG. 3 schematically illustrates an example of a data table showing user information;

FIG. 4 schematically illustrates an example of a data table showing dish provider information;

FIG. 5 schematically illustrates an example of a data table showing deliverer information;

FIG. 6 schematically illustrates an example of a data table showing advertising information;

FIG. 7 is a sequence diagram illustrating an example of whole processing including the processing of the information processing system according to the embodiment;

FIG. 8 schematically illustrates an example of an advertising message created from the advertising information in Application Example 1;

FIG. 9 schematically illustrates Application Example 2 of the information processing system in the embodiment;

FIG. 10 schematically illustrates Application Example 3 of the information processing system in the embodiment;

FIG. 11 schematically illustrates an example of an advertising message created from advertising information in Application Example 3; and

FIG. 12 schematically illustrates another example of the advertising message created from the advertising information in Application Example 3.

### DETAILED DESCRIPTION OF THE EMBODIMENTS

### Background of Present Disclosure

As described above, the food delivery services are becoming increasingly common. There is a technique of, if the maximum amount of items that a deliverer can deliver in one trip is not reached, providing advertisements to users near a user who has already ordered, thereby encouraging the neighborhood users to order, increasing the amount of items to be delivered in one trip (that is, consolidating deliveries), and improving delivery efficiency.

However, in the food delivery services, not only delivery, which is an intended service by the conventional technique, is provided, but also a delivery dish is prepared. Since preparation of a dish and delivery are sequential tasks, in some cases, it may be difficult to maintain the quality of a delivery dish while providing efficient delivery. Here, a user who ordered first is also referred to as a first user, and neighborhood users are also referred to as second users. For instance, depending on the kind of dish (second dish) ordered by a second user, there is a possibility of not being able to prepare a dish (second dish) ordered by the second user in parallel with a dish (first dish) ordered by the first user. In this case, since the dish ordered by the second user is prepared after the completion of the dish ordered by the first user, the dish ordered by the first user may get cold, which may result in a decrease in the quality of the dish ordered by the first user. Thus, it may be difficult to maintain the quality of the delivery dish while providing efficient delivery (e.g., delivering the dishes to the users in one trip).

As such, the information processing method according to an aspect of the present disclosure includes the following processing performed by using a computer. The first order representing an order for a first dish is received from a first terminal operated by a first user. A second dish capable of being prepared in parallel with the first dish is determined. Information to encourage ordering the second dish is created. A location associated with the first user is obtained. A second user is identified in accordance with the location associated with the first user. The information is sent to a second terminal operated by the second user.

In such case, as the second user identified in accordance with the location associated with the first user is, for example, a user near the first user, if the second user who saw the information to encourage ordering the second dish ordered the second dish, it is possible to deliver dishes (first dish and second dish) to the respective users (first user and second user) in one trip. That is, efficient delivery is made possible through, for example, consolidation of deliveries. In addition, the task of preparing a dish is performed more efficiently when preparing the second dish that can be prepared in parallel with the first dish, compared with when preparing a dish that cannot be prepared in parallel with the first dish. This enables to complete the first dish and the second dish at the same time, for example. That is, it is possible to suppress, for example, the first dish from getting cold and thus to maintain the quality of the first dish. Accordingly, both the maintenance of quality of the delivery dish and efficient delivery are made possible. This can consequently promote the use of the food delivery services.

An amount of time to prepare the first dish may further be obtained. An end time for receiving an order for the second dish may be calculated in accordance with the amount of time to prepare the first dish.

In such case, the deadline to order the second dish is provided, thereby facilitating to coincide the completion of the first dish and the completion of the second dish. This facilitates to maintain the quality of the first dish.

The second user may be associated with a location within a predetermined distance from the location associated with the first user.

In such case, the destination to which the second dish will be delivered is within a predetermined distance from the location of the first user (e.g., near the first user). This facilitates to deliver the first dish and the second dish in one trip, which enables to provide more efficient delivery.

A delivery route to deliver the first dish to the location associated with the first user may further be determined. The second user may be associated with a location within a predetermined distance from a location on the delivery route.

In such case, the destination to which the second dish will be delivered is within a predetermined distance from a location on the delivery route to deliver the first dish to the first user (e.g., near the delivery route). This facilitates to deliver the first dish and the second dish in one trip, which enables to provide more efficient delivery.

A second dish provider different from a first dish provider at which the first dish ordered by the first user is prepared may further be selected. The second dish may include a dish capable of being prepared at the second dish provider.

In such case, through the information to encourage the second user to order the second dish, it is possible to encourage ordering, as the second dish, not only a dish that can be prepared at the first dish provider but also a dish that can be prepared at the second dish provider. This increases kinds of dishes selectable by the second user, which enables to further promote the use of the food delivery services.

The second dish provider may be associated with a location within a predetermined distance from a location associated with the first dish provider.

In such case, the location of the second dish provider is within a predetermined distance from the first dish provider (e.g., near the first dish provider). Thus, it is possible for a deliverer to also stop by the second dish provider without significantly changing the delivery route through which the deliverer will stop by the first dish provider and deliver the first dish to the first user. Accordingly, even if the first dish and the second dish are delivered in one trip, it is possible to suppress a delay in the delivery of the first dish to the first user.

A delivery route to deliver the first dish to the location associated with the first user may further be determined. The second dish provider may be associated with a location within a predetermined distance from a location on the delivery route.

In such case, the location of the second dish provider is within a predetermined distance from a location on the delivery route to deliver the first dish to the first user (e.g., near the delivery route). Thus, it is possible for the deliverer to also stop by the second dish provider without significantly changing the delivery route through which the deliverer will stop by the first dish provider and deliver the first dish to the first user. Accordingly, even if the first dish and the second dish are delivered in one trip, a delay in the delivery of the first dish to the first user can be suppressed.

A scheduled delivery time at which the first dish is scheduled to be delivered to the first user may be obtained. The second dish may include a dish capable of being prepared so that a delay in the scheduled delivery time is less than a predetermined time period.

In addition, delivery time required for delivering the first dish to the first user may be obtained, the delivery time being counted from completion of the first dish. The second dish may include a dish capable of being prepared so that an extension of the delivery time is less than a predetermined time period.

In such case, efficient delivery is made possible while suppressing a delay in the delivery of the first dish to the first user.

A second dish capable of being prepared before the first dish is prepared or before a predetermined time period elapses since the first dish is prepared may be determined.

In such case, a decrease in the quality of the first dish can be suppressed more reliably.

The information may be an advertisement to encourage ordering the second dish.

In such case, it is possible to directly encourage the second user to order the second dish.

An information processing system according to an aspect of the present disclosure includes: a reception unit that receives, from a first terminal operated by a first user, the first order representing an order for a first dish; a determination unit that determines a second dish capable of being prepared in parallel with the first dish; a creation unit that creates information to encourage ordering the second dish; an obtainment unit that obtains a location associated with the first user; an identification unit that identifies a second user in accordance with the location associated with the first user; and a sender that sends the information to a second terminal operated by the second user.

Accordingly, it is possible to provide the information processing system that enables both the maintenance of quality of the delivery dish and efficient delivery.

Hereinafter, embodiments are described in detail with reference to the Drawings.

It should be noted that all the embodiments described below represent comprehensive or specific examples. Numerical values, shapes, structural elements, the arrangement and connection of the structural elements, steps, the order of the steps, and others described in the embodiments below are mere examples and are not intended to limit the present disclosure. Among the structural elements in the embodiments below, the structural elements not recited in the independent claims representing superordinate concepts are described as optional structural elements.

### Embodiment

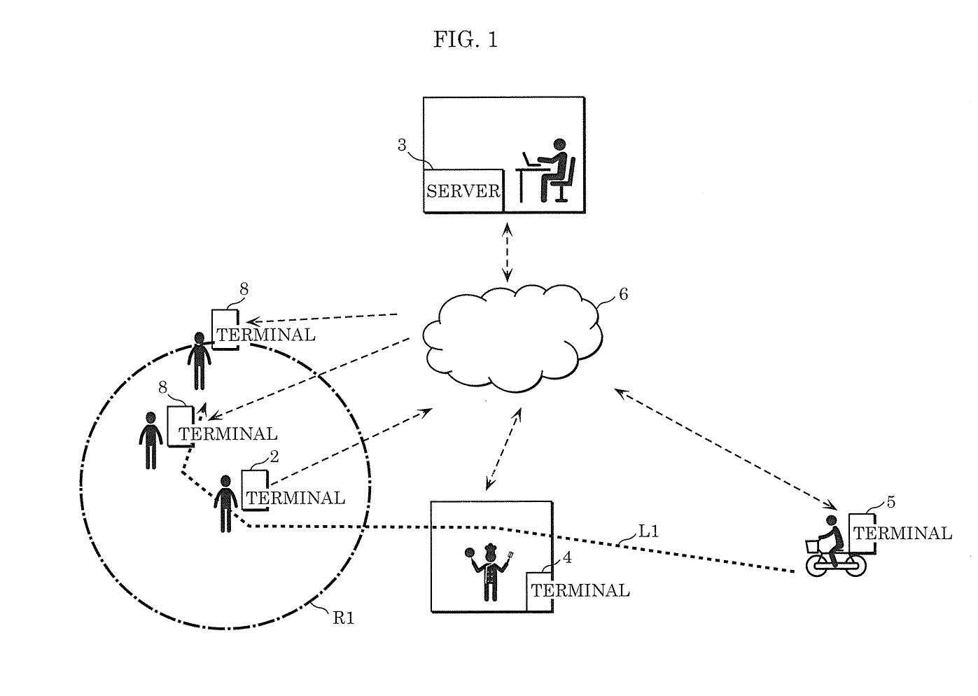

Hereinafter, an embodiment is described with reference to FIGS. 1 to 12. It should be noted that Application Example 1 to Application Example 3 are described as application examples of an information processing system in the present disclosure.

### Application Example 1

First, Application Example 1 is described.

FIG. 1 schematically illustrates Application Example 1 of the information processing system in the embodiment. Hereinafter, a server is described as an example of the information processing system in the present disclosure. As illustrated in FIG. 1, in Application Example 1, server 3 communicates with terminal 2 (first terminal), terminal 4, terminal 5, and terminals 8 (second terminals) via network 6. Terminal 2 is operated by a person who ordered a dish. Terminal 4 is operated by a dish provider at which the ordered dish is prepared. Terminal 5 is operated by a deliverer. Terminals 8 are operated by particular persons near the orderer. Any communications protocol of a wireless or wired network may be applied to communication through network 6.

The person who orders a dish via terminal 2 by operating terminal 2 is a user (also referred to as a first user) of an organization that operates a food delivery service provided, for example, by using server 3. The dish ordered by the first user via terminal 2 is also referred to as a first dish. The dish provider that operates terminal 4 and at which the first dish ordered by the first user is prepared is also referred to as a first dish provider. The particular persons who operate terminals 8 and who are present near the first user are users (also referred to as second users) of the organization that operates the food delivery service.

Here, server 3 is described briefly. Server 3 stores information regarding preregistered users, information regarding preregistered dish providers, and information regarding preregistered deliverers and has a function to provide advertising messages to the users. For instance, when receiving an order for a delivery dish (the first order representing an order for the first dish) from terminal 2 of the first user, server 3 asks terminal 4 of the first dish provider whether they can prepare the first dish (for example, this inquiry includes an instruction to prepare the first dish) and whether there are dishes that they can prepare in addition to the first dish. The dishes that can be prepared in addition to the first dish are also referred to as second dishes. Moreover, server 3 extracts a candidate deliverer capable of delivering the first dish and, at the same time, asks terminal 5 whether a dish (dishes) to be prepared in addition to the first dish can be delivered in addition to the first dish in one trip. Server 3 extracts the second users by using the information regarding the pre-stored users. For instance, server 3 extracts the second users present within a predetermined distance from the location of the first user (within area R1). Server 3 creates advertising messages containing the name of an additionally orderable dish and sends the advertising messages to terminals 8 operated by the extracted second users.

If the second users ordered the second dishes, taking delivery route L1 through the location of the first dish provider, the location of the first user, and the locations of the second users, the deliverer collects the first dish and the second dishes at the first dish provider and delivers the first dish to the first user and the second dishes to the respective second users.

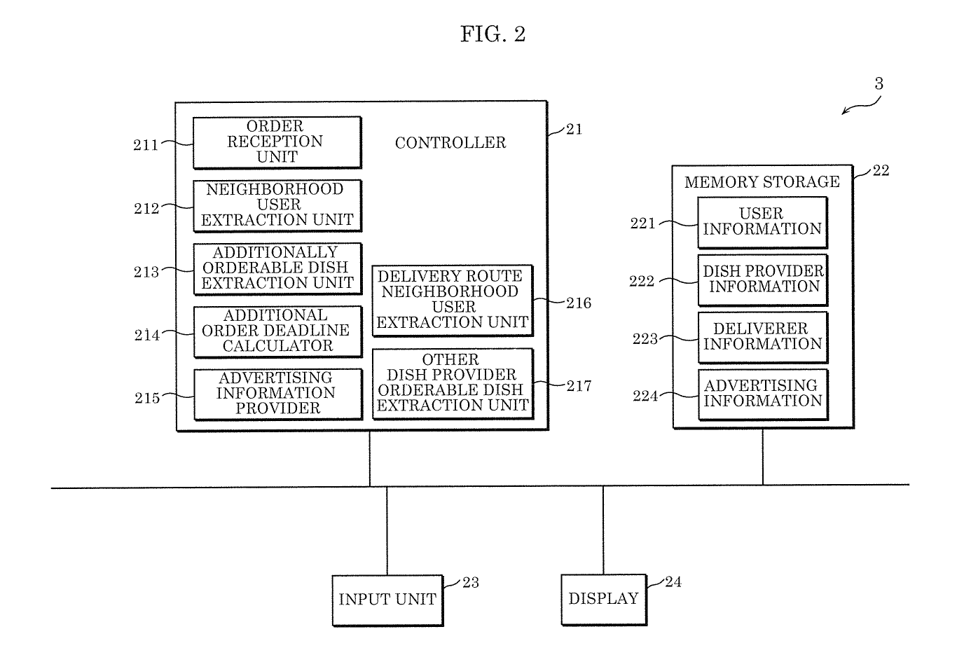

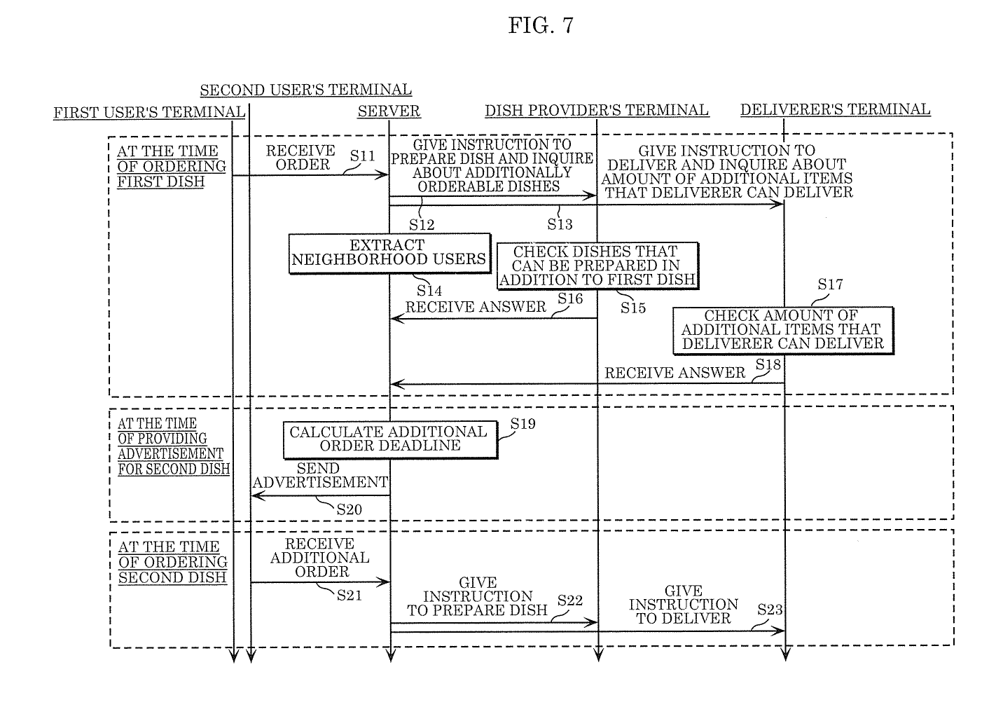

FIG. 2 schematically illustrates the configuration of the information processing system (server 3) in the embodiment. Server 3 includes controller 21, memory storage 22, input unit 23, and display 24. Server 3 is a device including components such as a processor (microprocessor), memory, user interfaces, and a communication circuit. It should be noted that the memory may include memory other than memory storage 22. The memory (memory storage 22) is, for example, ROM or RAM and can store control programs run by the processor. Input unit 23 and display 24 are examples of the user interfaces. As its functional constituent components, controller 21 includes order reception unit 211, neighborhood user extraction unit 212, additionally orderable dish extraction unit 213, additional order deadline calculator 214, advertising information provider 215, delivery route neighborhood user extraction unit 216, and other dish provider orderable dish extraction unit 217. The functional constituent components of controller 21 are caused to operate by, for example, the communication circuit in server 3 or the processor that runs the control programs stored in the memory. The functional constituent components of controller 21 are described with reference to FIG. 7, which is described later. Memory storage 22 stores user information 221, dish provider information 222, deliverer information 223, and advertising information 224.

Controller 21 can communicate with the respective functional constituent components of server 3 through a wired or wireless network by using, for example, the communication circuit. For instance, in accordance with information input from input unit 23, display 24 displays the result of execution by controller 21 where appropriate.

In preparation for abnormal conditions in controller 21, a terminal operated by the administrator of server 3 may separately have a function similar to that of controller 21. For instance, controller 21 performs automatic control. However, when an abnormality occurs, it is possible for the administrator to directly control controller 21 (function similar to that of controller 21) by operating the terminal. It should be noted that a safe system that enables to minimize a possibility of being affected (e.g., attacked) by a third party is employed in a communications system through which controller 21 and the terminal operated by the administrator communicate with each other.

Memory storage 22 is memory storage such as a hard disk drive or flash memory. Memory storage 22 stores pieces of information input from input unit 23, via controller 21 and pieces of information obtained by controller 21. For instance, memory storage 22 stores pieces of information, such as user information 221, dish provider information 222, deliverer information 223, and advertising information 224, as data necessary to provide a food delivery service.

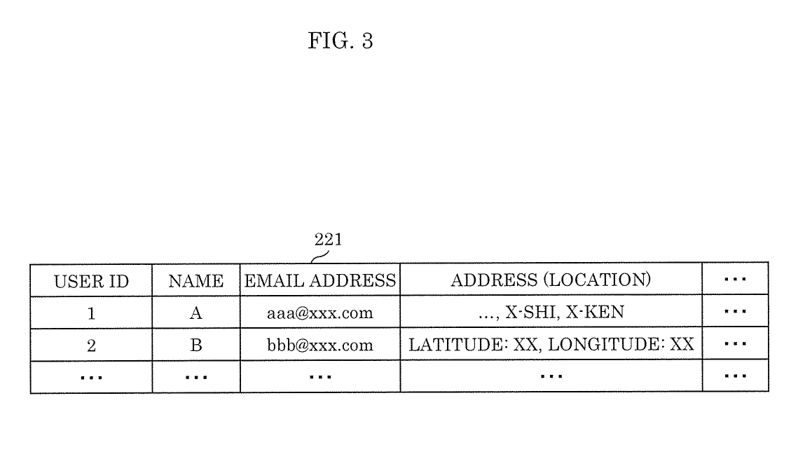

User information 221 is the information regarding preregistered users. The users are the users of organizations that operate the food delivery services provided by using server 3. User information 221 is described with reference to FIG. 3.

FIG. 3 schematically illustrates an example of a data table showing user information 221. As illustrated in FIG. 3, user information 221 contains, for example, user IDs uniquely identifying the users, the names of the users, the email addresses of the users, and the addresses (locations) of the users. Although not illustrated in FIG. 3, the gender and the family structure of each user and further information may be contained. The pieces of information are stored in memory storage 22 in the following manner, for example. The administrator of server 3 inputs the information via input unit 23, or a person who wishes to be a user inputs the information via a terminal or another device at the time of user registration. It should be noted that regarding the location information contained in user information 221, a user's current location may be updated and stored by consecutively sending, via network 6, information indicating the user's current location (location of the portable terminal of a user) to server 3 from the portable terminal that the user carries around and that uses global positioning system (GPS) information. For instance, regarding the user associated with user ID1, a preregistered address is shown, whereas regarding the user associated with user ID2, a latitude and a longitude obtained from GPS information are shown.

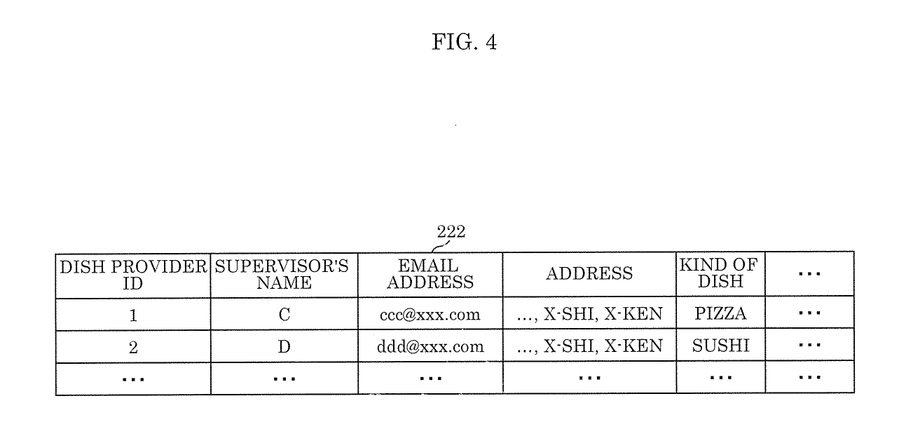

Dish provider information 222 is the information regarding preregistered dish providers. These dish providers are available in the food delivery services. Dish provider information 222 is described with reference to FIG. 4.

FIG. 4 schematically illustrates an example of a data table showing dish provider information 222. As illustrated in FIG. 4, dish provider information 222 contains, for example, dish provider IDs uniquely identifying the dish providers, the names of the supervisors of the dish providers, the email addresses of the dish providers, the addresses of the dish providers, and the kind of dish that can be provided by each dish provider. The pieces of information are stored in memory storage 22 in the following manner, for example. The administrator of server 3 inputs the information via input unit 23, or, for example, a dish provider's supervisor who wishes to receive orders for dishes from the users inputs the information via a terminal or another device at the time of registration. It should be noted that although in FIG. 4, dish provider information 222 contains the addresses of the dish providers, for example, for a mobile shop, dish provider information 222 may contain location information obtained using GPS information.

Deliverer information 223 is the information regarding preregistered deliverers. The deliverers collect dishes at the dish providers and deliver the dishes to the users. The deliverers may belong to the dish providers or may be couriers or ordinary people who wish to deliver (ordinary people in the sense of not being involved in the delivery business). The ordinary people are such people who deliver, for example, while they are at it (e.g., while they are out) if they are available when server 3 made a request.

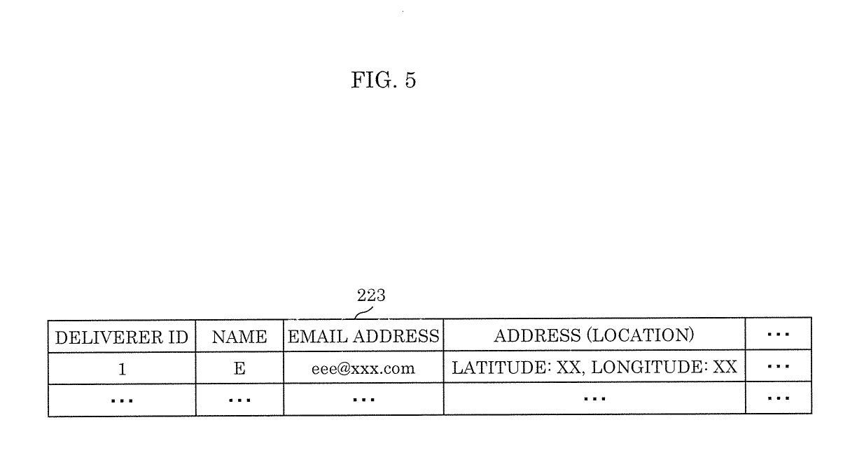

FIG. 5 schematically illustrates an example of a data table showing deliverer information 223. As illustrated in FIG. 5, deliverer information 223 contains, for example, the deliverer IDs uniquely identifying the deliverers, the names of the deliverers, the email addresses of the deliverers, and the addresses (locations) of the deliverers. The pieces of information are stored in memory storage 22 in the following manner, for example. The administrator of server 3 inputs the information via input unit 23, or, for example, a company or a person who wishes to deliver in the food delivery services inputs the information via a terminal or another device at the time of registration. It should be noted that regarding the location information contained in deliverer information 223, a deliverer's current location may be updated and stored by consecutively sending, via network 6, information indicating the deliverer's current location (location of the portable terminal of a deliverer) to server 3 from the portable terminal that the deliverer carries around and that uses GPS information.

Advertising information 224 is advertising information provided to the users. The advertising information is sent to the terminals of the users (second users) by email or appears on, for example, a web browser on the terminals of the second users.

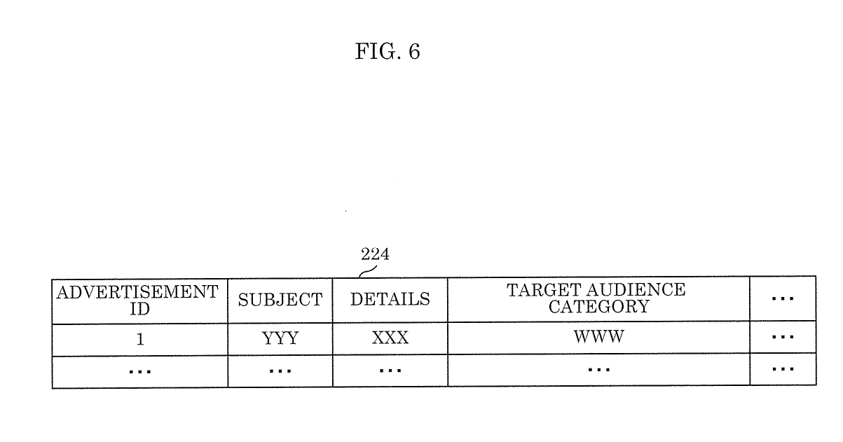

FIG. 6 schematically illustrates an example of a data table showing advertising information 224. As illustrated in FIG. 6, advertising information 224 contains, for example, advertisement IDs uniquely identifying advertisements, the subjects of the advertisements, the details of the advertisements, and target audience categories. It should be noted that the target audience categories correspond to information regarding the characteristics of the second users to which advertisements are provided. The target audience categories are based on, for example, gender, address, and family structure. As an example, an advertisement suitable for the category of women is an advertisement targeting women (e.g., advertisement emphasizing a dish with a low calorie count or a smaller portion size), whereas an advertisement suitable for the category of families is an advertisement targeting families (e.g., advertisement emphasizing a dish for children or with a large portion size). For instance, the advertisement IDs are each associated with an advertising message based on the advertisement target audience category, and an advertising message is selected in accordance with the characteristics of each user to which an advertisement will be sent. It should be noted that the details of an advertisement contain, for example, the name of an additionally orderable dish, an additional order deadline, and special offer information. The details are described later.

Since memory storage 22 stores multiple kinds of IDs, such as the user IDs, the dish provider IDs, the deliverer IDs, and the advertisement IDs, for example, the number of digits of an ID code is different for each kind of ID. However, there is a possibility of a user and a deliverer being an identical person. Thus, server 3 may separately have such an information processing function that enables to determine whether a user ID and a deliverer ID are the IDs of an identical person. Moreover, in preparation for abnormal conditions in memory storage 22, server 3 may separately have memory storage holding information similar to the information contained in memory storage 22 (back up data).

The special offer information is information on a special offer that applies, for example, to a second user as a result of the second user ordering the additionally orderable dish by the additional order deadline. As an example of the special offer, a discount on the second dish ordered by the second user, an increase in the portion of the second dish, awarding of points, preferential treatment available at the time of future ordering, or awarding of another incentive is considered.

It should be noted that a special offer for the first user, such as a discount on the first dish ordered by the first user, an increase in the portion of the first dish, awarding of points, preferential treatment available at the time of future ordering, or awarding of another incentive may separately be provided. If the special offer also applies to the first user, it can be expected that the first user encourages the second users to order. In addition, if only the first user cannot receive the special offer, many of the users may wait for a neighborhood user to order first, wishing to take advantage of the special offer shown in the advertising message when placing an order, which may result in a decrease in the number of orders. Thus, the special offer may also apply to the first user.

Input unit 23 has functions including a function to directly drive controller 21 and a function to manage the information stored in memory storage 22. Input unit 23 is an input device, such as a keyboard, a mouse, a pointing device, or a touch panel. Controller 21 normally operates automatically in accordance with received information. However, a user may control controller 21 via input unit 23. In addition, the user may store, for example, new user information in memory storage 22 via input unit 23 or update, for example, the pre-stored user information. The use of input unit 23 by the user enables the maintenance management of server 3.

Display 24 has functions including a function to display, for example, the status of server 3. Display 24 is a component such as a display. For instance, the user can control controller 21 or input information, via input unit 23, while looking at information displayed on display 24.

Hereinafter, with reference to FIG. 7, whole procedure from the reception of orders for dishes to the delivery of the dishes to users is described.

FIG. 7 is a sequence diagram illustrating an example of whole processing including the processing of the information processing system (server 3) according to the embodiment.

An order is sent to server 3 by the first user performing, via terminal 2 of the first user, an operation to determine a delivery dish, for example, on a website or an app. Thus, order reception unit 211 receives the order (step S11). Order reception unit 211 is an example of a reception unit that receives, from terminal 2 operated by the first user, the first order representing an order for the first dish.

When receiving the first order, server 3 gives terminal 4 of the first dish provider an instruction to prepare the first dish and asks terminal 4 whether there are additionally orderable dishes that can be prepared in parallel with the first dish (step S12). Here, an activity from the reception of the order to the completion of the dish is referred to as preparation of a dish. An additionally orderable dish corresponds to a second dish and can be prepared in parallel with the first dish. It should be noted that being able to prepare in parallel means being able to complete more than one dish, for example, within a determined time period in accordance with more than one order. For instance, the second dish includes a dish that can be prepared in parallel with the first dish. This facilitates to complete more than one dish within the determined rime period. For instance, a dish that can be prepared before the first dish is prepared or before a predetermined time period elapses since the first dish is prepared is determined to be a second dish. The determined time period corresponds to an amount of time to prepare the first dish or the sum of the amount of time to prepare the first dish and the predetermined time period. That is, the first dish and the second dish are completed almost simultaneously. Even if the first dish and the second dish can be prepared in parallel, in the case in which preparing the second dish takes longer than preparing the first dish, the quality of the first dish may decrease. However, by determining the second dish in this manner, it is possible to more reliably suppress the quality of the first dish from decreasing. In addition, the determined time period is determined so as to prevent a situation in which despite being completed and prepared to be delivered, the first dish cannot be delivered due to the preparation of the second dish. That is, the determined time period is determined so as not to affect the scheduled delivery time at which the first dish is scheduled to be delivered to the first user (that is, so as not to cause a delivery delay). For instance, controller 21 obtains the scheduled delivery time at which the first dish is scheduled to be delivered to the first user. The second dish includes a dish that can be prepared so that a delay in the scheduled delivery time is less than a predetermined time period. It should be noted that controller 21 may obtain delivery time necessary to deliver the first dish to the first user, the delivery time being counted from completion of the first dish. The second dish may include a dish capable of being prepared so that an extension of the delivery time is less than a predetermined time period. It should be noted that as long as the second dish can be prepared so as not to affect the scheduled delivery time at which the first dish is scheduled to be delivered to the first user (e.g., so that a delay in the scheduled delivery time at which the first dish is scheduled to be delivered to the first user is less than the predetermined time period), the first dish and the second dish do not necessarily have to be prepared in parallel. For instance, if one of the amount of time to prepare the first dish and an amount of time to prepare the second dish is less than the other, the first dish and the second dish are, in some cases, not prepared in parallel.

In addition, when receiving the first order, server 3 gives terminal 5 of the deliverer an instruction to deliver the first dish prepared at the first dish provider and asks terminal 5 about the amount of items that the deliverer can deliver in addition to the first dish in one trip (step S13). It should be noted that if one of the ordinary people is chosen as a deliverer, a person who resides near the first dish provider or a person who is currently near the first dish provider is chosen as the deliverer, for example.

When server 3 has received the first order, neighborhood user extraction unit 212 extracts second users present near the destination to which the first order will be delivered (first user) (step S14). Neighborhood user extraction unit 212 is an example of an obtainment unit that obtains a location associated with the first user and an example of an identification unit that identifies second users in accordance with the location associated with the first user. The location associated with the first user corresponds to the address (location) of the first user contained in user information 221. If the first user wishes to have the first dish delivered to the address of the first user, the location associated with the first user corresponds to the address of the first user. Meanwhile, if the first user wishes to have the first dish delivered to the current location of the first user, the location associated with the first user corresponds to a location identified, for example, by the GPS information of terminal 2 of the first user. Identifying the second users in accordance with the location associated with the first user specifically means identifying the second users associated with locations within a predetermined distance from the location associated with the first user (within area R1). Since the second users are associated with respective addresses (locations) in user information 221, neighborhood user extraction unit 212 can extract the second users whose addresses (locations) are within area R1. It should be noted that server 3 may separately have a function to identify the whereabouts of each user by using past GPS information records in a case in which the whereabouts of the user cannot be identified (for example, the address of the user is not registered in user information 221, and the location of the user cannot be identified by using GPS information as the terminal of the user is switched off or is out of the service area).

It should be noted that the processing of step S12 to the processing of step S14 are performed simultaneously, for example, but may be performed at different times. If the processing of step S12 to the processing of step S14 are performed at different times, the order of the processing of step S12 to the processing of step S14 is not limited to a particularly order. In addition, the processing of step S14 may be performed after the processing of step S16 (reception of an answer from the first dish provider), which is described later, or the processing of step S18 (reception of an answer from the deliverer), which is described later.

To answer the inquiry about the additionally orderable dishes (second dishes) that can be prepared in parallel with the first dish, the first dish provider checks whether there are second dishes that they can prepare (step S15). For instance, the first dish provider checks whether enough time, space, or staff are available until the first dish is completed and thus it is possible to prepare the second dishes in parallel with the first dish. The following assumes that the first dish provider sells pizzas (that is, the first dish is a pizza). In this instance, when cooking the first dish with a cooking device, such as a pizza oven, if there is an available space in the cooking device, the first dish provider determines to be able to cook additional pizzas (second dishes) in parallel with the first dish. Here, the quantity of pizzas is determined in accordance with the available space in the cooking device. The first dish provider informs server 3 of the names of the checked additionally orderable second dishes and the quantities of the respective second dishes, and additionally orderable dish extraction unit 213 obtains the list of the names of the additionally orderable second dishes (step S16). Additionally orderable dish extraction unit 213 is an example of a determination unit that determines second dishes that can be prepared in parallel with the first dish.

To answer the inquiry about the amount of items that the deliverer can deliver in addition to the first dish in one trip, the deliverer checks the amount of additional items that the deliverer can deliver (step S17). The deliverer then informs server 3 of the checked amount of additional items that the deliverer can deliver (step S18).

When the answers from the first dish provider and the deliverer show that a second dish can be prepared in parallel with the first dish at the first dish provider and that the deliverer can deliver the second dish in addition to the first dish, additional order deadline calculator 214 calculates a deadline for the additional order (order for the second dish) (step S19). Additional order deadline calculator 214 obtains an amount of time to prepare the first dish and an amount of time to prepare the second dish. For instance, dish provider information 222 contains an amount of time to prepare a dish for each kind of dish and an amount of time necessary for each quantity. By comparing the kind of the first dish and the quantity indicated in the order from the first user with dish provider information 222 and comparing the kind of the second dish and the quantity informed by the first dish provider with dish provider information 222, additional order deadline calculator 214 obtains the amount of time to prepare the first dish and the amount of time to prepare the second dish. Alternatively, additional order deadline calculator 214 may directly obtain the amount of time to prepare the first dish and the amount of time to prepare the second dish from the first dish provider, for example. In accordance with the obtained amount of time to prepare the first dish and the obtained amount of time to prepare the second dish, additional order deadline calculator 214 then calculates a deadline to receive an order for the second dish from a second user. Specifically, additional order deadline calculator 214, for instance, subtracts the amount of time to prepare the second dish from the time at which the first dish is scheduled to be completed, i.e., the time obtained by adding the amount of time to prepare the first dish to the current time, and determines the time obtained as a result of the subtraction to be the deadline to order the second dish (additional order deadline). It should be noted that the deadline may be based on, for example, elapsed time since transmission of an advertisement to the terminal of the second user (or reception of the advertisement by the second user).

Advertising information provider 215 creates an advertising message containing the name of the additionally orderable second dish, the quantity of the items, and the additional order deadline and sends the advertising message to terminal 8 operated by the second user (step S20). Here, the quantity of the items is, for example, a smaller one of the quantity of the items (second dish) that can be prepared at the first dish provider and the quantity of the items (second dish) that the deliverer can deliver in addition to the first dish. Advertising information provider 215 is an example of a creation unit that creates information to encourage ordering a second dish and an example of a sender that sends the created information to terminals 8 operated by the second users. It should be noted that in the present embodiment, the information to encourage ordering the second dish is an advertisement to encourage ordering the second dish. Here, a method via the internet, for example, via email or push notification can be considered as an example of the method of sending the information. Since delivery to the second user is made near the first user who ordered first, it is easy to calculate the time at which the second dish will arrive at the second user. Thus, the advertising message may contain the scheduled delivery time at which the second dish is scheduled to be delivered to the second user.

When receiving an order for the second dish from terminal 8 of the second user by the additional order deadline (step S21), server 3 gives terminal 4 of the first dish provider an instruction to prepare the second dish (step S22) and gives terminal 5 of the deliverer an instruction to deliver the second dish to the second user (step S23). It should be noted that the instruction to the deliverer may contain information indicating, for example, the order in which the dishes are delivered or delivery route L1 through the first dish provider, the first user, and the second user.

For instance, the processing performed by server 3 is performed automatically. Specifically, treating the reception of an order for the first dish from the first user (step S11) as a trigger, server 3 automatically performs the processing of step S12 to the processing of step S14. Moreover, treating the reception of an answer from the first dish provider and an answer from the deliverer (steps S16 and S18) as a trigger, server 3 automatically performs the processing of step S19 and the processing of step S20. Treating the reception of an order for the second dish from the second user (step S21) as a trigger, server 3 automatically performs the processing of step S22 and the processing of step S23. It should be noted that under a particular condition, for example, at the time of occurrence of a malfunction, in a case in which an order from a user contains a special condition, or in a case in which an answer from the first dish provider or an answer from the deliverer contains a special condition, the processing performed by server 3 may partially be performed manually via, for example, input unit 23.

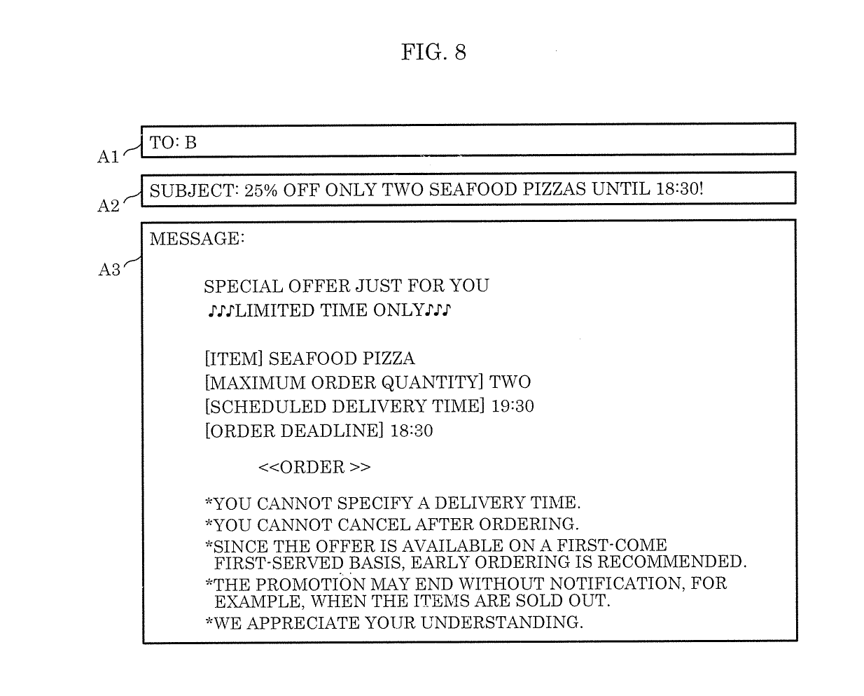

Next, with reference to FIG. 8, a specific example of an advertising message sent to terminal 8 operated by one of the second users in Application Example 1 is described.

FIG. 8 schematically illustrates an example of an advertising message created from the advertising information in Application Example 1. Part A1 is a section to indicate an address. Specifically, in accordance with the information contained in user information 221, part A1 is filled in with, for example, the name or email address of a second user extracted by neighborhood user extraction unit 212. Part A2 is a section to indicate a subject. Specifically, part A2 is filled in with pieces of information such as the name of an additionally orderable dish (second dish), the quantity of the items, an additional order deadline, and special offer information in the details of an advertisement contained in advertisement information 224. Here, the second dish is seafood pizza, the quantity of the items is two, the additional order deadline is 18:30, and the special offer information is 25% off. Part A3 is a section to indicate the body of the advertising message. Specifically, part A3 is filled in with pieces of information such as the name of the additionally orderable dish (second dish), the quantity of the items, a scheduled delivery time, and the additional order deadline in the details of the advertisement contained in advertising information 224. For instance, the templates of advertising messages as shown in FIG. 8 are individually associated with the respective advertisement Ills contained in advertising information 224. Here, part A2 is described as an example. There is a template of “[discount rate] only [quantity] [name of second dish] until [additional order deadline]!”. The words, “only”, “until”, and “!” in the template are fixed words, and “[discount rate], [quantity], [name of second dish], and [additional order deadline]” are automatically filled in with an answer from the first dish provider and information based on the result of calculation by additional order deadline calculator 214. Moreover, the name of the second dish and further information shown in the advertising message are determined in accordance with the advertisement target audience category to which the second user belongs. For instance, if the answer from the first dish provider contains different kinds of second dishes, the advertising message contains the name of a second dish selected from the different kinds of second dishes so as to be most suitable for the second user in terms of the advertisement target audience category. It should be noted that the address and the subject, which are contained here in the advertising message, do not necessarily have to be contained. In addition, part A3 contains information for guiding the second user to place an order. For instance, [<<ORDER>>] in part A3 corresponds to such information, and the information is associated with, for example, a link to open a webpage for ordering or a command to open, for example, an app. The information may also be a phone number or an email address for ordering. This facilitates for the receiver of the advertising message to place an order.

### Application Example 2

Next, Application Example 2 is described.

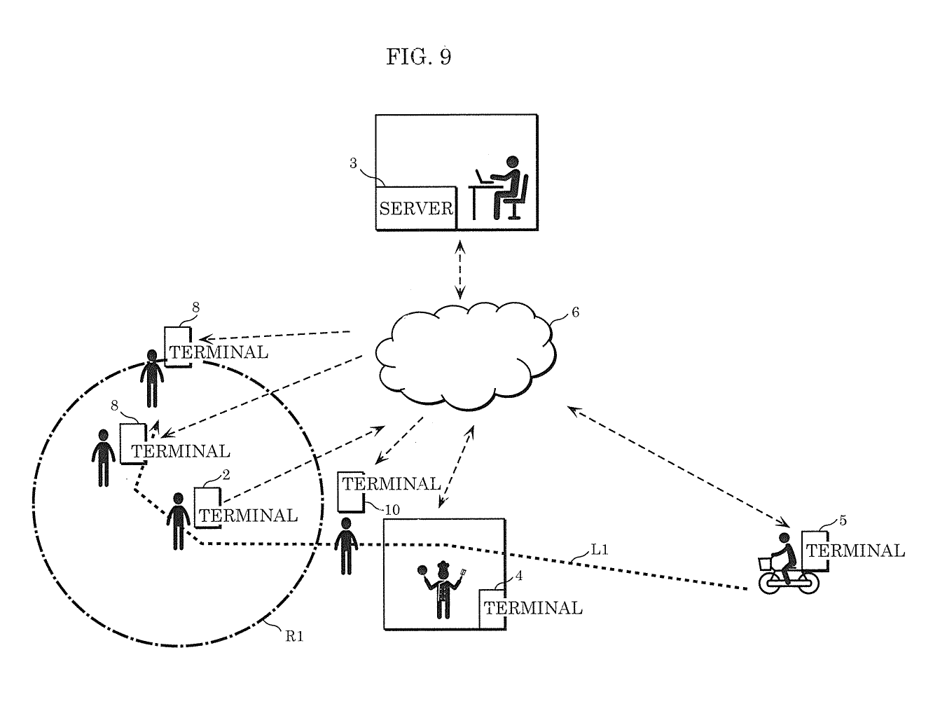

FIG. 9 schematically illustrates Application Example 2 of the information processing system (server 3) in the embodiment. In addition to Application Example 1 in FIG. 1, FIG. 9 includes (i) a user associated with a location within a predetermined distance from a location on delivery route L1 to deliver a dish to the first user and (ii) terminal 10 operated by the user. The user is referred to as a second user. That is, second users may be associated with the locations within the predetermined distance from the location associated with the first user or associated with locations within the predetermined distance from a location on delivery route L1. In this application example, both the users associated with the locations within the predetermined distance from the location associated with the first user and the user associated with the location within the predetermined distance from a location on delivery route L1 are referred to as second users. It should be noted that the second users do not have to be both types of users but may be either type of users.

The description below focuses on configuration, operation, and other aspects different from those in Application Example 1, and explanations for the same configuration and operation and other same aspects as those in Application Example 1 are omitted where appropriate. When receiving an order for the first dish, delivery route neighborhood user extraction unit 216 determines a route to deliver the first dish to the location associated with the first user (specifically, route from the address (current location) of the deliverer through the first dish provider to the first user). Neighborhood user extraction unit 212 extracts the second user present within the predetermined distance from a location on delivery route L1 between the first dish provider and the end of delivery route L1. It should be noted that the location of the second user corresponds to an address pre-registered in user information 221 or is identified by using, for example, the GPS information of terminal 10 operated by the second user. Moreover, as in the case of Application Example 1, in Application Example 2, neighborhood user extraction unit 212 also identifies the second users associated with the locations within the predetermined distance from the location associated with the first user (within area R1). Advertising messages are sent not only to terminals 8 of the second users associated with the locations within the predetermined distance from the location associated with the first user but also to terminal 10 of the second user associated with the location within the predetermined distance from a location on delivery route L1. For instance, when server 3 has received an order for the second dish from the second user carrying around terminal 10, the route to deliver the first dish to the first user is updated so as to pass through the second user, resulting in a slight change from the original delivery route. Information indicating updated delivery route L1 is sent to terminal 5 operated by the deliverer.

The remaining part of the whole processing, which includes the processing of server 3, is identical to that in Application Example 1, except for that the second users include the user carrying around terminal 10.

### Application Example 3

Next, Application Example 3 is described.

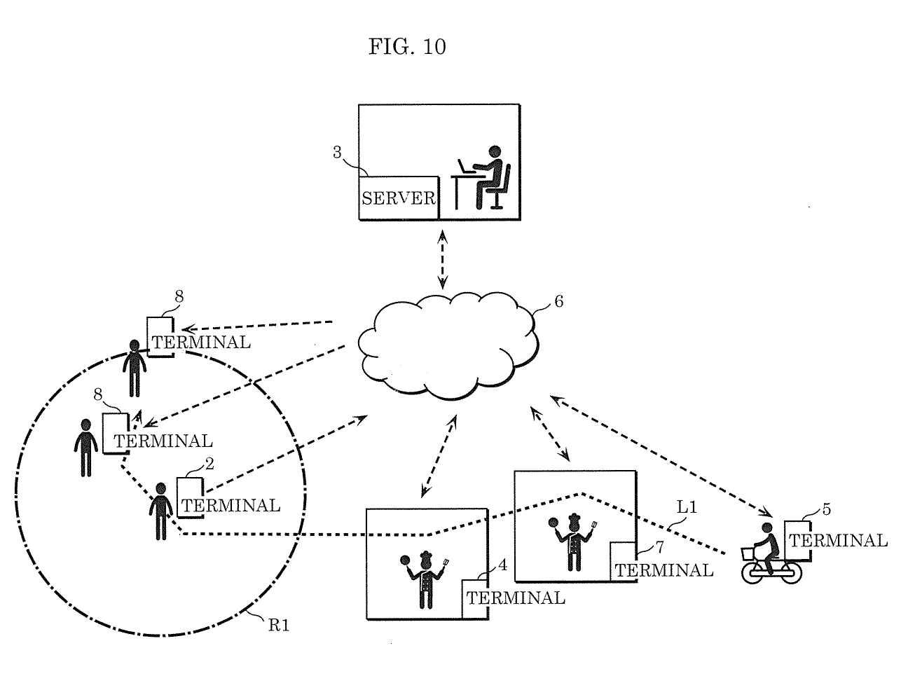

FIG. 10 schematically illustrates Application Example 3 of the information processing system (server 3) in the embodiment. In addition to Application Example 1 in FIG. 1, FIG. 10 includes (i) a dish provider associated with a location within a predetermined distance from a location on delivery route L1 to deliver the first dish to the first user and (ii) terminal 7 of the dish provider. The dish provider is a second dish provider different from the first dish provider at which the first dish ordered by the first user is prepared. That is, in this application example, the second dish provider different from the first dish provider at which the first dish is prepared is also a candidate dish provider that can receive an order for a second dish. It should be noted that although not shown in FIG. 10, the second dish provider may be a dish provider associated with a location within a predetermined distance from a location associated with the first dish provider (e.g., near the first dish provider).

By checking whether there is a second dish that can be prepared in parallel with the first dish, a candidate dish provider that can receive an order for the second dish is selected. Specifically, as a way to check the above matter, information regarding dishes capable of being prepared is consecutively sent from terminal 7 to server 3, or an inquiry is made directly to the dish provider associated with the location within the predetermined distance from a location on delivery route L1 or the dish provider associated with the location within the predetermined distance from the location associated with the first dish provider. When checking the above matter, whether there is a second dish that can be prepared without affecting the scheduled delivery time at which the first dish is scheduled to be delivered to the first user is checked. For instance, in consideration of an amount of time to prepare the dish and extra time necessary to stop by the second dish provider, whether there is a second dish that can be prepared without affecting the scheduled delivery time at which the first dish is scheduled to be delivered to the first user is checked. If there is a second dish provider that can provide the second dish capable of being prepared in parallel with the first dish, advertising messages promoting the second dish provided by the second dish provider are sent to the second users.

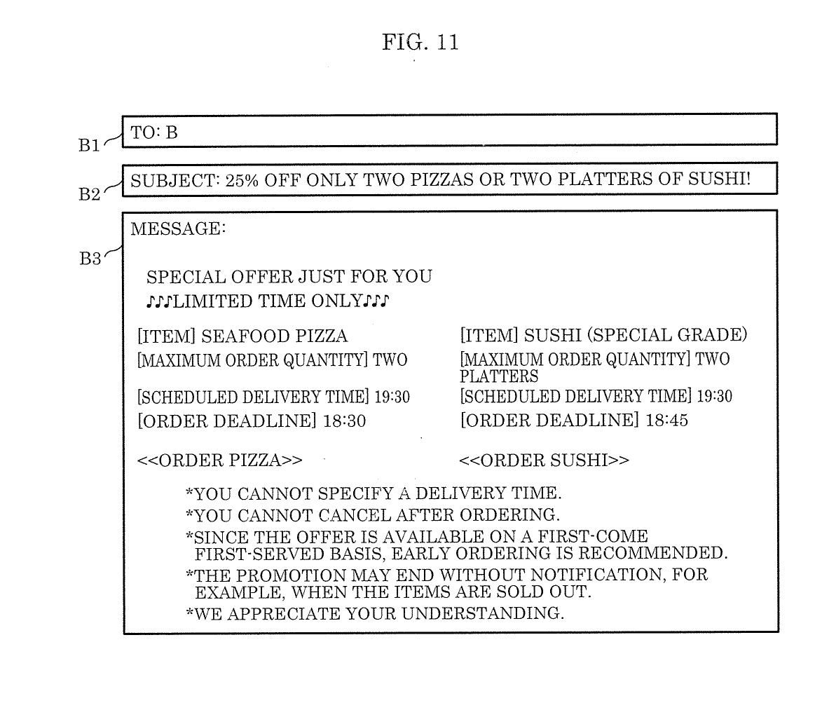

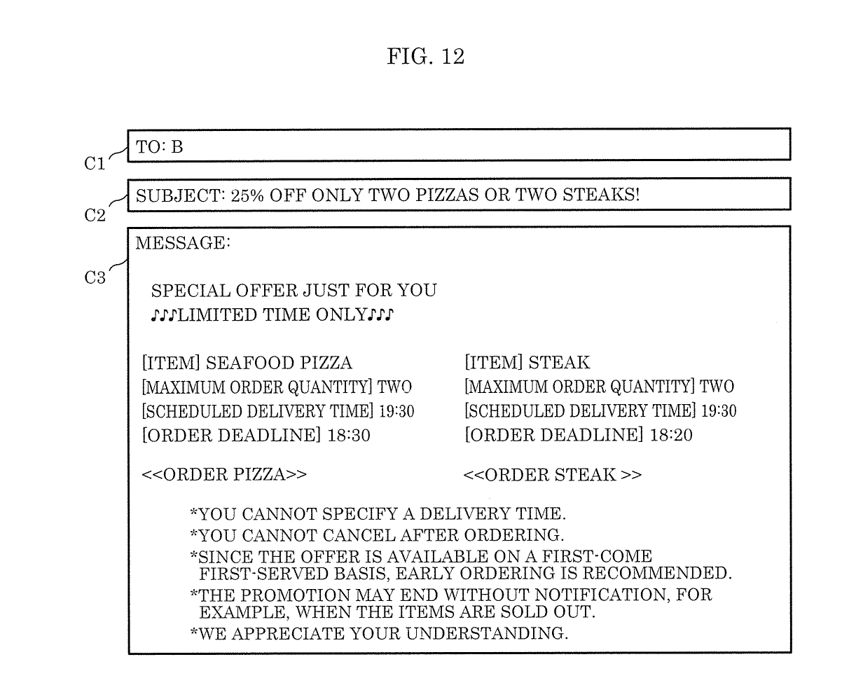

When server 3 has received an order for the second dish (additional order) provided by the second dish provider, different from the first dish provider that has received the order for the first dish, delivery route Li is updated so as to also pass through the second dish provider. Then, information indicating updated delivery route L1 is sent to terminal 5 operated by the deliverer. Thus, there is an increase in kinds of additionally orderable dishes (second dishes) appearing on advertising messages and selectable by the second users. This means that the advertising messages enable to strongly encourage the second users to use the dish providers (food delivery services). Hereinafter, with reference to FIGS. 11 and 12, advertising messages each showing not only a second dish provided by the first dish provider but also a second dish provided by the second dish provider are described.

FIG. 11 schematically illustrates an example of an advertising message created from advertising information 224 in Application Example 3. Part B1 is a section to indicate an address. Specifically, in accordance with the information contained in user information 221, part B1 is filled in with, for example, the name or email address of a second user extracted by neighborhood user extraction unit 212. Part B2 is a section to indicate a subject. Specifically, part B2 is filled in with pieces of information such as the names of additionally orderable dishes (second dishes), the quantities of the items, and special offer information in the details of an advertisement contained in advertisement information 224. In Application Example 1, only pizza is shown as an example of a second dish that can be prepared at the first dish provider. However, in Application Example 3, sushi is also shown as an example of a second dish that can be prepared at the second dish provider. In Application Example 1, part A2 contains the additional order deadline. However, in Application Example 3, since the additional order deadline for pizza and the additional order deadline for sushi differ from each other, part B2 does not contain the additional order deadlines. However, part B2 may contain the additional order deadline for pizza and the additional order deadline for sushi. Part B3 is a section to indicate the body of the advertising message. For instance, in Application Example 3, in addition to the information regarding the second dish provided by the first dish provider, pieces of information regarding the second dish provided by the second dish provider, such as the quantity of the items, a scheduled delivery time, and the additional order deadline, are shown. As illustrated in FIG. 11, the additional order deadline can be set for each dish provider or each kind of dish.

For instance, it is assumed that the first dish provided by the first dish provider (e.g., pizza shop) is scheduled to be completed at 19:00. If the second dish provided by the first dish provider is seafood pizza that takes, for example, 30 minutes to prepare, the deadline to order seafood pizza is set to be 18:30. The first dish provided by the first dish provider is scheduled to be completed at 19:00, and as illustrated in FIG. 10, since the second dish provider (e.g., sushi shop) is located en route to the first dish provider, the deliverer will arrive at the second dish provider before arriving at the first dish provider. Thus, the second dish provider needs to complete the second dish before 19:00. For instance, it is assumed here that the second dish provider needs to complete the second dish at 18:50. Thus, if the second dish provided by the second dish provider is sushi that takes, for example, five minutes to prepare, the deadline to order sushi is set to be 18:45. Sushi, which takes a short time to prepare, is shown as an example in FIG. 11. Steak, which takes a long time to prepare, is shown as an example in FIG. 12.

FIG. 12 schematically illustrates another example of an advertising message created from the advertising information in Application Example 3. Part C1 is a section to indicate an address. Specifically, in accordance with the information contained in user information 221, part C1 is filled in with, for example, the name or email address of a second user extracted by neighborhood user extraction unit 212. Part C2 is a section to indicate a subject. Specifically, part C2 is filled in with pieces of information such as the names of additionally orderable dishes (second dishes), the quantities of the items, and special offer information in the details of an advertisement contained in advertisement information 224. In Application Example 1, only pizza is shown as an example of a second dish that can be prepared at the first dish provider. However, in Application Example 3, steak is also shown as an example of a second dish that can be prepared at the second dish provider. In Application Example 1, part A2 contains the additional order deadline. However, in Application Example 3, since the additional order deadline for pizza and the additional order deadline for steak differ from each other, part C2 does not contain the additional order deadlines. However, part C2 may contain the additional order deadline for pizza and the additional order deadline for steak. Part C3 is a section to indicate the body of the advertising message. For instance, in Application Example 3, in addition to the information regarding the second dish provided by the first dish provider, pieces of information regarding the second dish provided by the second dish provider, such as the quantity of the items, a scheduled delivery time, and the additional order deadline, are shown. As illustrated in FIG. 12, the additional order deadline can be set for each dish provider or each kind of dish.

For instance, it is assumed that the first dish provided by the first dish provider (e.g., pizza shop) is scheduled to be completed at 19:00. If the second dish provided by the first dish provider is seafood pizza that takes, for example, 30 minutes to prepare, the deadline to order seafood pizza is set to be 18:30. The first dish provided by the first dish provider is scheduled to be completed at 19:00, and as illustrated in FIG. 10, since the second dish provider (e.g., sushi shop) is located en route to the first dish provider, the deliverer will arrive at the second dish provider before arriving at the first dish provider. Thus, the second dish provider needs to complete the second dish before 19:00. For instance, it is assumed here that the second dish provider needs to complete the second dish at 18:50. Thus, if the second dish provided by the second dish provider is steak that takes, for example, 30 minutes to prepare, the deadline to order steak is set to be 18:20.

It should be noted that the deadline to order the second dish at the second dish provider can also vary according to the location of the second dish provider. For instance, in Application Example 3, the second dish provider is between the deliverer and the first dish provider. However, the second dish provider may be between the first dish provider and the first user. In this instance, the deadline to order the second dish provided by the second dish provider may be later than the additional order deadline described in Application Example 3. Specifically, since the deliverer will arrive at the second dish provider after arriving at the first dish provider, the second dish provider needs to complete the second dish later than 19:00. For instance, it is assumed here that the second dish provider needs to complete the second dish at 19:10. If the second dish provided by the second dish provider is sushi, the deadline to order sushi that takes, for example, five minutes to prepare is set to be 19:05. If the second dish provided by the second dish provider is steak, the deadline to order steak that takes, for example, 30 minutes to prepare is set to be 18:40.

### SUMMARY

As described above, a second user identified in accordance with a location associated with the first user is, for example, a user present near the first user. Thus, if the second user who saw information to encourage ordering a second dish ordered the second dish, it is possible for a deliverer to deliver multiple dishes (first dish and second dish) to the respective users (first user and second user) in one trip. This enables efficient delivery. In addition, the task of preparing a dish is performed more efficiently when preparing the second dish that can be prepared in parallel with the first dish, compared with when preparing a dish that cannot be prepared in parallel with the first dish. This enables to complete the first dish and the second dish at the same time. That is, it is possible to suppress, for example, the first dish from getting cold and thus to maintain the quality of the first dish. Accordingly, both the maintenance of quality of the delivery dish and efficient delivery are made possible. This can promote the use of the food delivery services.

### Other Embodiment

The information processing system (server 3) in the present disclosure is described in accordance with the above embodiment. However, the present disclosure is not limited to the above embodiment. Modifications will be obtained by making various changes conceived by those skilled in the art to the above embodiment and by combining constituent components in the different embodiments. Unless being materially departed from the novel teachings and advantages of the present disclosure, all such modifications are intended to be included within the scope of the present disclosure.

For instance, although the information processing system is described as a server in the above embodiment, the information processing system is not limited to the server, but may be, for example, a computer. Moreover, the constituent components of server 3 may be included in multiple servers (computers) in a distributed manner.

For instance, although including input unit 23 and display 24 in the above embodiment, server 3 does not necessarily have to include input unit 23 or display 24.

For instance, although including additional order deadline calculator 214 and other dish provider orderable dish extraction unit 217 in the above embodiment, controller 21 does not necessarily have to include additional order deadline calculator 214 or other dish provider orderable dish extraction unit 217.

For instance, data on the past records of, for example, advertising messages sent to the second users or whether an order for a second dish has been placed as a result of sending an advertising message may be accumulated. The data can be used to create improved advertising messages in the future or can be used as data for machine learning.

In the above embodiment, as an example, the information to encourage ordering the second dish is described as an advertisement. However, the information is not limited to an advertisement. Specifically, the information may be information to identify a second dish which the second users are encouraged to order. For instance, the information may be information to identify a second dish from multiple dishes appearing on a web browser screen or application screen. The information may be used to display an emphasized second dish or a selected second dish on the screen.

For instance, in the above embodiment, the second users are selected in accordance with the location of the first user. However, the second users may further be narrowed down in accordance with the order history of each of the second users. For instance, neighborhood user extraction unit 212 obtains the order history of each of the second users selected in accordance with the location of the first user and selects second users who may order with high possibilities, in accordance with the order history. In addition, the second users may further be narrowed down in accordance with the relationship with the first user. For instance, neighborhood user extraction unit 212 obtains a relationship between the first user and each of the second users selected in accordance with the location of the first user and selects second users who each have a particular relationship with the first user (for example, family user, friend, or person who shares a similar taste).

In addition, the present disclosure can be realized not only as the information processing system but also as the information processing method including steps (processing) performed by the constituent components of the information processing system.

Specifically, as illustrated in FIG. 7, the information processing method includes the following processing performed by using a computer. The first order representing an order for a first dish is received from a first terminal (terminal 2) operated by a first user (step S11). A second dish capable of being prepared in parallel with the first dish is determined (step S16). Information (e.g., advertisement) to encourage ordering the second dish is created (step S20). A location associated with the first user is obtained (step S14). A second user is identified in accordance with the location associated with the first user (step S14). The information (e.g., advertisement) is sent to a second terminal operated by the second user (step 20).

For instance, a computer (computer system) may perform these steps. The present disclosure can be realized as a program designed to cause the computer to perform the steps of the method. Moreover, the present disclosure can be realized as a non-transitory computer-readable recording medium on which the program is recorded, such as CD-ROM.

For instance, if the present disclosure is realized as a program (software), the steps are performed by running the program by using hardware resources, such as the CPU, memory, and input/output circuit of the computer. That is, the steps are performed by the CPU obtaining data from, for example, the memory or the input/output circuit and performing computations and by the CPU outputting the result of computations to, for example, the memory or the input/output circuit.

Each of the constituent components of the information processing system in the above embodiment may be made as a dedicated circuit or a general circuit. The constituent components may be included in one circuit or more than one circuit.

The constituent components of the information processing system in the above embodiment may be fabricated as large scale integration (LSI), which is an integrated circuit (IC). Each of the constituent components may be made as one chip, or some or all of the constituent components may be included in one chip. The LSI may also be referred to as system LSI, super LSI, or ultra LSI in accordance with the level of integration.

The integrated circuit is not limited to the LSI, but may be a dedicated circuit or a general purpose processor. A field-programmable gate array (FPGA) that can be programmed or a reconfigurable processor in which a connection between circuit cells inside the LSI and the setting of the circuit cells can be reconfigured may be used.

Thanks to the advancement in the semiconductor technology or by using another derivative technology, a new integrated-circuit technology, which will replace the LSI technology, may appear. If such a technology appears, the constituent components of the information processing system may, of course, be fabricated within an integrated circuit by using the new technology.

Only some embodiments of the present disclosure have been described in detail above. Modifications will be obtained by making various changes conceived by those skilled in the art to the above embodiment and by combining the constituent components and functions in the different embodiments without materially departing from the novel teachings and advantages of the present disclosure. All such modifications are intended to be included within the scope of the present disclosure.

### INDUSTRIAL APPLICABILITY

An aspect of the present disclosure is applicable to the food delivery services or other services, for example.

What is claimed is:

1. An information processing method, comprising the following processing performed by using a computer:
receiving, from a first terminal operated by a first user, a first order representing an order for a first dish;
determining a second dish capable of being prepared in parallel with the first dish;
creating information to encourage ordering the second dish;
obtaining a location associated with the first user;
identifying a second user in accordance with the location associated with the first user; and
sending the information to a second terminal operated by the second user.

2. The information processing method according to claim 1, further comprising:
obtaining an amount of time to prepare the first dish; and
calculating an end time for receiving an order for the second dish, in accordance with the amount of time to prepare the first dish.

3. The information processing method according to claim 1,
wherein the second user is associated with a location within a predetermined distance from the location associated with the first user.

4. The information processing method according to claim 1, further comprising:
determining a delivery route to deliver the first dish to the location associated with the first user,
wherein the second user is associated with a location within a predetermined distance from a location on the delivery route.

5. The information processing method according to claim 1, further comprising:
selecting a second dish provider different from a first dish provider at which the first dish ordered by the first user is prepared,
wherein the second dish includes a dish capable of being prepared at the second dish provider.

6. The information processing method according to claim 5,
wherein the second dish provider is associated with a location within a predetermined distance from a location associated with the first dish provider.

7. The information processing method according to claim 5, further comprising:
determining a delivery route to deliver the first dish to the location associated with the first user,
wherein the second dish provider is associated with a location within a predetermined distance from a location on the delivery route.

8. The information processing method according to claim 1, further comprising:
obtaining a scheduled delivery time at which the first dish is scheduled to be delivered to the first user,
wherein the second dish includes a dish capable of being prepared so that a delay in the scheduled delivery time is less than a predetermined time period.

9. The information processing method according to claim 1, further comprising:
obtaining delivery time required for delivering the first dish to the first user, the delivery time being counted from completion of the first dish,
wherein the second dish includes a dish capable of being prepared so that an extension of the delivery time is less than a predetermined time period.

10. The information processing method according to claim 1, further comprising:
determining a second dish capable of being prepared before the first dish is prepared or before a predetermined time period elapses since the first dish is prepared.

11. The information processing method according to claim 1,
wherein the information is an advertisement to encourage ordering the second dish.

12. An information processing system, comprising:
a reception unit configured to receive, from a first terminal operated by a first user, a first order representing an order for a first dish;
a determination unit configured to determine a second dish capable of being prepared in parallel with the first dish;
a creation unit configured to create information to encourage ordering the second dish;
an obtainment unit configured to obtain a location associated with the first user;
an identification unit configured to identify a second user in accordance with the location associated with the first user; and
a sender that sends the information to a second terminal operated by the second user.
